(19) United States
(12) Patent Application Publication
(10) Pub. No.: US 2026/0274711 A1
(43) Pub. Date: Sep. 17, 2026

(54) MINERAL CRYSTALLIZER SYSTEMS AND METHODS FOR SOLIDS SEPARATION

(71) Applicant: Localized Water Solutions, LLC, Austin, TX (US)

(72) Inventors: Bobby Paul Johnston, Tomball, TX (US); Michael Paul O’Brien, Houston, TX (US); Wayne Allan Wolf, San Marcos, TX (US)

(21) Appl. No.: 19/566,175

(22) Filed: Mar. 13, 2026

Related U.S. Application Data
(60) Provisional application No. 63/771,684, filed on Mar. 14, 2025.

(51) Int. Cl. C02F 1/10; B01D 1/00; B01D 1/22; B01D 1/24; B01D 5/00; C02F 1/04; C02F 1/08

(52) U.S. Cl. CPC C02F 1/10; B01D 1/0011; B01D 1/223; B01D 1/24; B01D 5/006; C02F 1/042; C02F 1/08

(57) ABSTRACT

Mineral Crystallizers systems and methods for solidifying dissolved minerals including a ball mill evaporator. The systems and methods include wetting heated media with a brine solution. The ball mill evaporator transports and agitates the heated media to disengage salt scale adhered to the heated media. The systems and methods enhance the transfer of heat into a brine and continuously remove salt scale as brine concentration approaches solid cake.

### CROSS-REFERENCE TO RELATED APPLICATIONS

This application claims the benefit of U.S. Provisional Patent Application No. 63/771,684, filed on Mar. 14, 2025, the entire contents of which are incorporated herein by reference.

### BACKGROUND

Current methods for converting a salty brine solution to solid cake include (1) reverse osmosis to extract fresh water from seawater, (2) using evaporation to remove fresh water from a concentrated brine, and (3) crystallization, where an evaporator output brine is concentrated to a level that salt precipitates. These processes present a plurality of challenges including (1) scaling, (2) material degradation, (3) inefficient heat transfer, (4) inefficient energy consumption, and (5) excessive solid crystallization. These challenges reduce efficiency, result in energy loss, and increase the cost of performing these methods.

### FIELD OF THE PRESENT DISCLOSURE

The present disclosure is generally directed to mineral crystallizers, more specifically to mineral crystallizer systems and methods utilizing a ball mill evaporator.

### BRIEF SUMMARY OF THE PRESENT DISCLOSURE

The present disclosure includes ball mill evaporator systems and methods for solidifying dissolved minerals from brine solutions through enhanced heat transfer and continuous scale removal.

In accordance with one aspect, a ball mill evaporator system is provided. The ball mill evaporator system comprises a rotating mechanism including a lower end and an upper end, a brine, a condenser, and a sorting component. The rotating mechanism receives heated media at the lower end. The heated media traverses the rotating mechanism from the lower end to the upper end. While traversing from the lower end to the upper end, the heated media is continuously agitated. At the upper end, steam of the heated media is directed to the condenser. The heated media is cooled. The cooled media is directed into the sorting component. The sorting component separates scale from the cooled media. The cooled media is directed to a heating device.

According to various embodiments, the ball mill evaporator system includes one or more of the following features. The heating device heats the media prior to being exposed to the brine. The rotating mechanism includes an Archimedes screw. The rotating mechanism is positioned at an incline. The ball mill evaporator system further comprises means for monitoring a density of the brine.

In accordance with another aspect, a ball mill evaporator system is provided. The ball mill evaporator system comprises a rotating mechanism including a central portion and an outer portion, a brine, and a self-cleaning component. The rotating mechanism is in fluid communication with at least one fluid stream. The at least one fluid stream flows through an interior channel of the central portion. The at least one fluid stream is heated. The rotating mechanism moves media from a lower position to a higher position. As the media moves from the lower position to the higher position, the media is heated via heat transfer from the at least one heated fluid stream. Scale adhered to a surface of the media descales as the media traverses the rotating mechanism. Once the media reaches the higher position, the media is operable to move from the central portion to the outer portion. The media falls onto a bottom of the outer portion. The self-cleaning component scrapes the media to remove the scale adhered to the surface of the media. The scale is collected in an outlet.

According to various embodiments, the ball mill evaporator system includes one or more of the following features. The rotating mechanism includes an auger. The media includes a plurality of spherical balls, and the plurality of spherical balls comprise a corrosion-resistant material. After the self-cleaning component scrapes the media to remove scale, the media reenters the rotating mechanism. When the heated media is at the higher position, steam from the heated media is captured and directed to a condenser.

In accordance with another aspect, a method of solidifying a dissolved mineral is provided. The method comprises heating media via a heating device. The method comprises introducing the heated media into a solution, wherein the solution comprises a dissolved mineral, and wherein the solution is positioned at a first end of a rotating mechanism of a ball mill evaporator. The method comprises transporting the heated media from the first end of the rotating mechanism to a second end of the rotating mechanism. The method comprises continuously agitating the heated media to disengage scale adhered to a surface of the heated media. The method comprises directing, at the second end of the rotating mechanism, steam from the heated media to a condenser. The method comprises collecting condensate from the condenser. The method comprises separating solidified scale from the media. The method comprises returning the media to the heating device.

According to various embodiments, the method includes one or more of the following features. The media includes a plurality of spherical balls, and the plurality of spherical balls comprise a corrosion-resistant material. The solution comprises a brine. The solution comprises at least one of sodium chloride, barium sulfate, strontium sulfate, calcium sulfate, ferric hydroxide, manganese oxide, copper oxide, amorphous silica, crystalline silica, quartz, calcium carbonate, and magnesium hydroxide. The rotating mechanism comprises a helical auger.

In at least one embodiment of the present disclosure, a ball mill evaporator system is disclosed. The ball mill evaporator system can concentrate a salty brine solution into a solid cake. The ball mill evaporator system may include a combination of a hot fluid and an insulated mill evaporator designed to heat spherical balls, thereby enhancing heat transfer into a brine solution. The spherical balls can be agitated against each other to promote uniform heat distribution and prevent scale buildup.

In at least one embodiment of the present disclosure, a ball mill evaporator system is disclosed. The ball mill evaporator system includes (1) a mechanism for enhancing the transfer of heat into a brine, promoting efficient evaporation and crystallization, (2) a sphere-filled evaporator that increases the evaporative surface area, facilitating faster evaporation and efficient crystallization, and (3) a self-clearing salt scale removal component that continuously removes salt scale as the brine concentration approach a solid cake. The ball mill evaporator system can increase an upper limit of an operating temperature. The continuous removal of salt scale enables higher steam discharge temperature, leading to enhanced energy recovery.

In at least one embodiment of the present disclosure, a ball mill evaporator system including a ball mill evaporator is disclosed. The ball mill evaporator system can heat (e.g., steam injection, jacketed heating) a plurality of spheres traversing the ball mill evaporator. The ball mill evaporator system is designed for the spheres to agitate against each other and to circulate from a lower end to an upper end of the ball mill evaporator. The ball mill evaporator system may include a rotating Archimedes screw and/or an auger concentrically located in an enclosed sleeve.

In at least one embodiment of the present disclosure, a ball mill evaporator is disclosed. The ball mill evaporator system includes a ball mill, a heating oven, a conveyor system, a brine basin, an Archimedes screw, a condenser, a brine monitor, and/or a slip stream. The Archimedes screw can lift spheres, resulting in a continuous agitation of the spheres to disengage salt scale adhered to the spheres and the Archimedes screw.

### BRIEF DESCRIPTION OF THE DRAWINGS

The embodiments illustrated, described, and discussed herein are illustrative of the present disclosure. As these embodiments are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the subject matter described herein, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

FIG. 1 depicts a schematic view of a ball mill evaporator system according to one or more embodiments of the subject matter disclosed herein.

FIG. 2 depicts a schematic view of a ball mill evaporator system according to one or more embodiments of the subject matter disclosed herein.

FIG. 3 depicts a schematic view of a ball mill evaporator system according to one or more embodiments of the subject matter disclosed herein.

FIG. 4 depicts a schematic view of a ball mill evaporator system according to one or more embodiments of the subject matter disclosed herein.

FIG. 5 illustrates a perspective view of a portion of a rotating mechanism of a ball mill evaporator system according to one or more embodiments of the subject matter disclosed herein.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a,” “an,” and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, “scale” may refer to any solid deposit, coating, layer, or accumulation that forms on a surface as a result of precipitation, crystallization, or deposition of dissolved or suspended materials from a fluid, including but not limited to mineral deposits, salt deposits, and any other inorganic or organic buildup.

In at least one embodiment of the present disclosure, a ball mill evaporator system is disclosed. The ball mill evaporator system includes a ball mill evaporator for concentrating a brine solution. The ball mill evaporator receives media (e.g., spherical balls) exposed to a brine. The brine may include sodium chloride, magnesium chloride, calcium chloride, potassium chloride, barium sulfate, strontium sulfate, calcium sulfate, ferric hydroxide, manganese oxide, copper oxide, amorphous silica, crystalline silica, quartz, calcium carbonate, magnesium hydroxide and combinations thereof. The media may be any corrosion-resistant material (e.g., stainless steel). The ball mill evaporator is configured to agitate the media to create a film of liquid on an exterior of the media. Heat can be applied via an injection of steam and/or external heating (e.g., jacketed heating). As the heat is applied, the brine evaporates, leaving a salt solution. The evaporated water vapor can be collected and removed via a vacuum system and/or condenser.

In at least one embodiment of the present disclosure, a ball mill evaporator system is disclosed. The ball mill evaporator system includes a ball mill evaporator designed to subject grinding media (e.g., plurality of spherical balls) to a toroidal path to create a salt slurry, salt paste, and/or a dry salt crystallized output. The ball mill evaporator includes a rotating mechanism (e.g., auger) that can transport the grinding media. The rotating mechanism is positioned inside a first jacketed chamber and can contain a hollow interior for receiving heated fluid. The ball mill evaporator may further include a second jacketed chamber positioned outside of the first jacketed chamber. The ball mill evaporator may include a support member (e.g., gusset/baffle) positioned between the first jacketed chamber and the second jacketed chamber. The rotating mechanism moves at a rotation speed for lifting heated grinding media in an upward path along the rotating mechanism. The heated grinding media can be exposed to a brine prior to traveling along the rotating mechanism. Brine may be inserted from a top end of the ball mill evaporator and wet the grinding media as the grinding media travels up the rotating mechanism. The brine may travel in a countercurrent manner relative to a direction of travel of grinding media. Once the grinding media reaches a top of the rotating mechanism, the grinding media can fall into the second jacketed chamber. Due to the movement of the rotating mechanism and following into the second jacketed chamber, the grinding media is constantly agitated, resulting in salt scale removal. After falling into the second jacketed chamber, the grinding media can be rewet via brine located at a bottom of the ball mill evaporator before traveling up the rotating mechanism again.

In some embodiments, heat may be introduced at a bottom end and/or a top end of the interior of the rotating mechanism. Additional heat may be applied at a bottom and/or a top end of the exterior jacketed chamber and designed to run in opposite direction of the interior heat. Heat may be applied at a top of the exterior jacketed chamber to heat the grinding media as the grinding media falls down the exterior jacketed chamber.

In some embodiments, the rotating mechanism includes a helical auger. The helical auger can include an uneven surface and/or a raised edge. For example, and without limitation, the helical blade can include a fin including a triangular shape that is pitched backward from a direction of travel. The grinding media may include a patterned exterior surface. The grinding media may include a diameter between about ⅝ inches (about 1.59 centimeters) to about 1.25 inches (about 3.18 centimeters).

In some embodiments, the ball mill evaporator system includes a saturated brine, an 80% salt slurry, and/or a dry crystallized output. In some embodiments, the ball mill evaporator system may include a sensor or similar component to monitor density, moisture content, pressure, and/or temperature throughout the ball mill evaporator system. The density of the steam rate to brine ratio can be altered to generate a desired output. In some embodiments, the ball mill evaporator system can include a vacuum component surrounding the rotating mechanism and/or other portions of the ball mill evaporator containing the grinding media. The ball mill evaporator system can maintain a pressure between about −0.5 bar to about 2 bar along the toroidal path of the grinding media (e.g., between the walls of a jacketed chamber). The ball mill evaporator system is configured to maintain a pressure of up to about 10 bar inside the walls of one or more of the jacketed chambers.

In some embodiments of the present disclosure, the ball mill evaporator system may be connected to a condensation system, a mechanical vapor recompression system, and/or a drying system. The ball mill evaporator system may receive raw water from an upstream feed. The ball mill evaporator system may, via a slurry conveyer, transmit a salt slurry and/or cake to a drying system. The drying system may dry the salt slurry and/or cake to a solid salt using a dry component (e.g., hot air belt dryer). The ball mill evaporator system may transmit steam to the mechanical vapor recompression system and/or the condensation system to condense the steam.

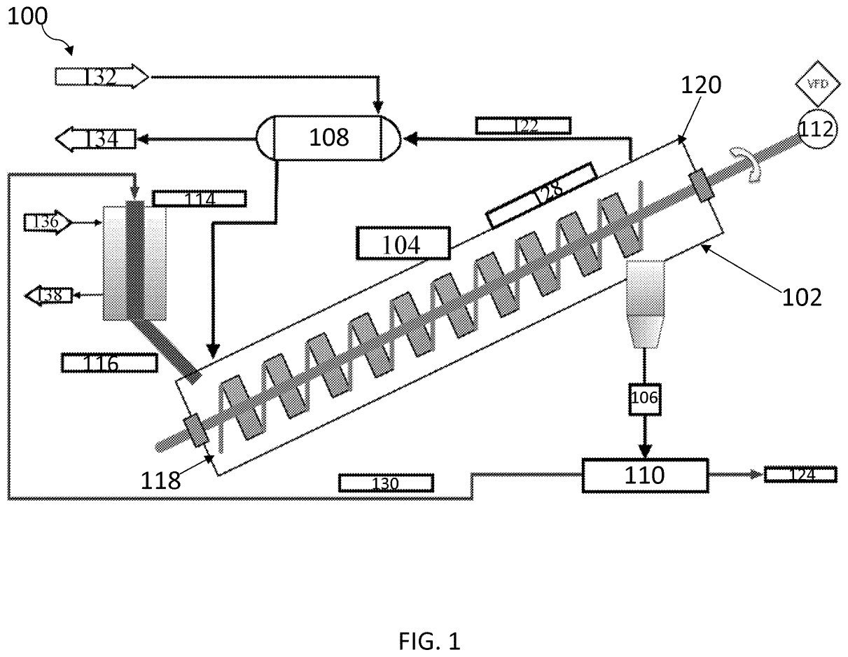

FIG. 1 illustrates a ball mill evaporator system according to at least one embodiment of the present disclosure. The ball mill evaporator system 100 includes a rotating Archimedes screw 102, a vacuum tube 104, an air lock device 106, a condenser 108, a sorting component (e.g., trommel) 110, a motor 112, and a heating device (e.g. heating oven) 114. The rotating Archimedes screw 102 may include insulation 126. The rotating Archimedes screw can be controlled via the motor 112. The motor may include a variable frequency drive for adjusting a frequency and voltage supplied to the motor. The rotating Archimedes screw 102 receives heated spheres 116 at a lower end 118 of the rotating Archimedes screw. The heated spheres 116 can be heated to a temperature configured to superheat (e.g., 100 to 300° C.) the steam from the brine. The heated spheres 116 can be introduced into a brine in a basin at the lower end 118 of the Archimedes screw. The rotating Archimedes screw 102 can transport the heated spheres from the lower end 118 to an upper end 120 of the rotating Archimedes screw. At the upper end 120 of the rotating Archimedes screw, steam 122 from the agitated heated spheres is directed to a condenser 108. As a result, the spheres are cooled, then the cooled spheres can fall to air lock device 106 before proceeding to a sorting component 110. The sorting component 110 separates remaining salt 124 from the spheres and the cooled spheres 130 can be sent to the heating oven 114 for reuse. The heating oven 114 receives hot salts 136 and releases cold salts 138. The condenser 108 can be in fluid connection with an inlet fluid stream 132. The condenser can transmit condensed steam 134 to a storage container.

In at least one embodiment of the present disclosure, a ball mill evaporator system including a ball mill evaporator positioned at an incline relative to a horizontal surface is disclosed. The ball mill evaporator can transport a plurality of spheres. The spheres can be heated in an external heating oven and conveyed to a lower end of the ball mill evaporator. The spheres are heated to a target temperature (e.g., between about 100° C. and about 300° C.) to superheat the steam evolved from the brine when the spheres are positioned at the upper end of the Archimedes Screw. The heated spheres are introduced into a brine in a basin at the lower end of the ball mill evaporator. The Archimedes screw agitates and lifts the heated spheres with a portion of the brine. The brine continues to wet the spheres as the spheres move up the Archimedes screw. The spheres are continuously agitated while traversing along the Archimedes screw, resulting in the disengagement of the salt scale that adheres to the sphere surface and the Archimedes screw.

Once the spheres reach an upper end of the inclined ball mill evaporator, the steam from the spheres is directed (e.g., conducted) to a condenser to collect the condensed steam. The spheres are returned to the heating oven through a steam lock device. The spheres may traverse to the steam lock device by falling after reaching an upper end of the Archimedes screw. The brine at the base of the mill is monitored and the slip stream is withdrawn for further dewatering by a centrifuge or filter press. The density of the brine can be monitored using a densometer. The concentration, temperature, and other characteristics of the ball mill evaporator system may be monitored. The treated water is returned to a storage container.

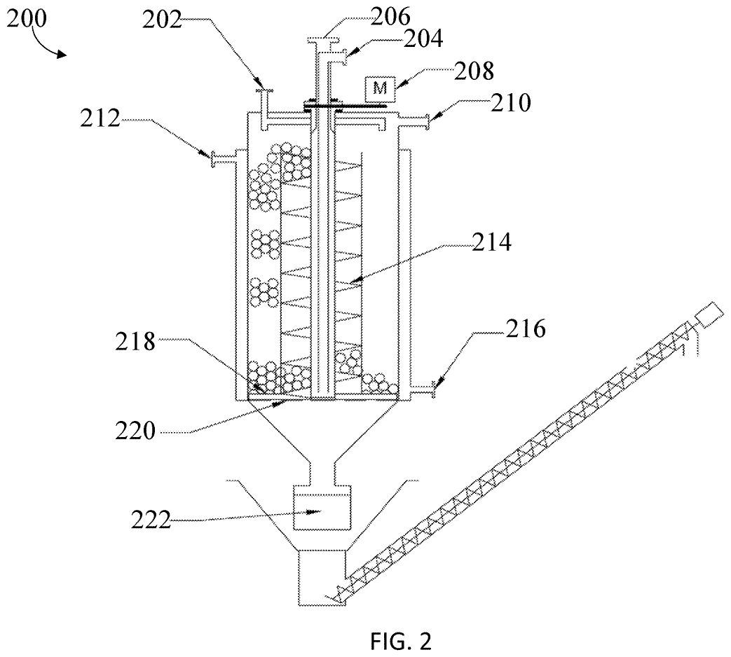

In at least one embodiment of the present disclosure, as shown in FIG. 2, a ball mill evaporator system is disclosed. The ball mill evaporator system 200 includes a brine inlet 202, a heating fluid inlet 204, a first heating fluid outlet 206, an auger drive motor 208, a steam outlet 210, a second heating fluid outlet 212, a helical auger 214, a second heating fluid inlet 216, a plurality of scraping blades 218, a perforated false floor 220, and a steam lock salt cake outlet 222. The ball mill evaporator system can heat (e.g., steam injection, jacketed heating) a plurality of spheres traversing the helical auger. The ball mill evaporator system is designed for the spheres to agitate against each other and to circulate from a lower end to an upper end of the helical auger.

The helical auger 214 is positioned within a central chamber of the ball mill evaporator system. The helical auger includes an interior portion for receiving heated fluid from the heating fluid inlet 204. As the heated fluid passes through the interior of the helical auger, heat can be transferred to spheres being moved by the auger.

Once the spheres reach an upper end of the auger, the spheres can spill over into a chamber outside of the central chamber. The outer chamber include a jacketed wall for maintaining energy efficiency. The outer chamber receives heated fluid via the second heating fluid inlet 216. As the spheres fall into the outer chamber, the spheres contact other spheres within the outer chamber, resulting in disengagement of salt scale on the spheres. The salt falls onto a floor (e.g., perforated false floor 220) of the outer chamber. A sweeping component (e.g., plurality of scraping blades 218) can continuously clean the floor of the outer chamber to prevent scale buildup.

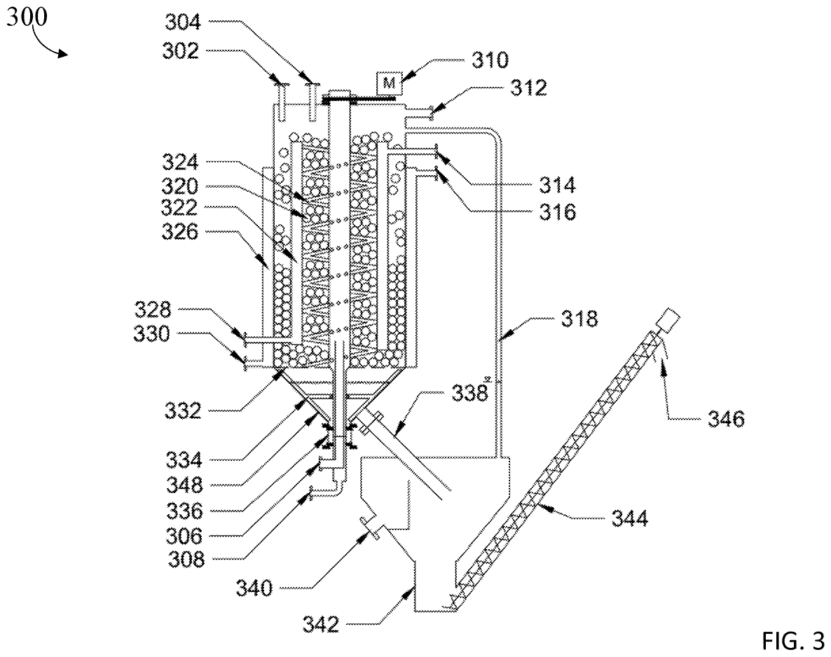

FIG. 3 illustrates a ball mill evaporator system 300 according to aspects of the present disclosure. The ball mill evaporator system 300 includes a vertical ball mill evaporator with at least two concentric chambers. The ball mill evaporator system 300 includes a brine inlet-annular space area 302 positioned at an upper portion of the ball mill evaporator system 300 for introducing brine into the ball mill evaporator system 300. A brine inlet-auger area 304 supplies brine to an auger area of the ball mill evaporator system 300. The ball mill evaporator system 300 includes an auger steam condensate outlet 308 and an evaporator steam outlet 312 for discharging steam and condensate during operation.

An auger drive motor 310 is positioned at the top of the ball mill evaporator system 300 and is configured to drive a hollow flight auger 324 positioned within a central chamber of the ball mill evaporator system 300. The hollow flight auger 324 extends vertically through the central portion of the ball mill evaporator and transports spherical grinding material 320 from a lower position to a higher position within the system. In some aspects, the hollow flight auger 324 has an outer diameter of approximately 48 inches (about 1.21 meters). A gap of approximately ⅜ inch (about 0.95 centimeters) is positioned between the outer diameter of the hollow flight auger 324 and an inner diameter of an auger sleeve. The hollow flight auger 324 may have a height of approximately 38 ft (about 11.58 meters) from a bottom blade to a top blade. In some aspects, a pitch of the hollow flight auger 324 is approximately 10 inches to manage cross-sectional area and steam flow. The hollow flight auger 324 may include a double helix shape to maximize heat transfer surface area. The hollow flight auger 324 may be built in sections with steam-tight joints, such as 10 ft (about 3.05 meters) sections for a 40 ft (about 12.19 meters) height configuration. Advantageously, this enables portions of the hollow flight auger 324 to be repaired without requiring the entire hollow flight auger 324 to be replaced.

With continued reference to FIG. 3, the evaporator steam outlet 312 is located at the upper portion of the ball mill evaporator system 300 for discharging steam generated during the evaporation process. The ball mill evaporator system 300 includes an auger sleeve steam jacket 322 surrounding the hollow flight auger 324. The auger sleeve steam jacket 322 receives heated fluid through an auger sleeve steam jacket inlet 314. An auger sleeve steam jacket condensate outlet 328 discharges condensate from the auger sleeve steam jacket 322. In some aspects, the auger sleeve steam jacket 322 has a width of approximately 2 inches (about 5.08 centimeters).

The central portion of the ball mill evaporator includes a jacketed inner chamber and the outer portion of the ball mill evaporator includes a jacketed outer chamber. Each of the jacketed inner chamber and the jacketed outer chamber is configured to receive heated fluid for maintaining energy efficiency. An evaporator wall steam jacket 326 surrounds the central chamber and forms the jacketed outer chamber. The evaporator wall steam jacket 326 receives heated fluid through an evaporator wall steam jacket inlet 316 and discharges fluid through an evaporator wall steam jacket condensate outlet 330.

Heat transfer within the ball mill evaporator system can occur through a plurality of surfaces in addition to the grinding media. For example, and without limitation, the hollow flight auger includes interior channels for receiving heated fluid and heat is transferred through the walls of the hollow flight auger directly to the brine and scale contacting the auger surface. As the grinding media travels along the hollow flight auger, the brine wets both the grinding media and the auger surface, causing evaporation to occur. Scale may accumulate on the auger surface as the brine evaporates and dissolved mineral precipitate.

In various aspects, a sleeve or similar component that surrounds a central chamber of a ball mill evaporator system receives heated fluid through an auger sleeve steam jacket. Heat is transferred through the sleeve wall to the brine positioned between the helical auger and the sleeve. The sleeve wall surface may accumulate scale as brine contacts and evaporates from the heated surface. The continuous movement of grinding media along the auger and against the sleeve wall may assist in removing scale that forms on these surfaces.

In at least one aspect, the evaporator wall steam jacket surrounding the outer chamber provides heat transfer through the exterior wall of the ball mill evaporator. Brine and grinding media contacting the jacketed outer wall receive heat, resulting in evaporation at the wall surface. Scale may form on the interior surface of the outer wall as dissolved minerals precipitate during evaporation. The tumbling action of the grinding media as it falls from the central portion to the outer portion may contact the outer wall and assist in dislodging scale accumulated thereon.

Ball mill evaporator system 300 may be configured to operate at a rotation speed of less than approximately 5 revolutions per minute (rpm), such as approximately 3-5 rpm. In some aspects, the ball mill evaporator system 300 may be configured to operate at a rotation speed up to approximately 10 rpm. A steam jacket pressure may be approximately 38 PSI (about 2.62 bar). The ball mill evaporator system 300 is configured to maintain a pressure between about −0.5 bar to about 2 bar along the toroidal path of the spherical grinding material 320. The ball mill evaporator system 300 is configured to maintain a pressure of up to about 10 bar inside the walls of one or more of the jacketed chambers.

At a lower portion of the ball mill evaporator system 300, a perforated plate 332 retains the spherical grinding material 320 while allowing salt and brine to pass through. The perforated plate 332 includes holes that are conical with thin side walls so that when the hollow flight auger 324 impacts the spherical grinding material 320 that has undergone size reduction (e.g., reduced diameter) from attrition forces (e.g., friction), the reduced spherical grinding material is forced through. The outer chamber may narrow near the perforated plate 332, resulting in the perforations being positioned underneath the inner chamber. An evaporator hopper base 348 is positioned below the perforated plate 332.

Evaporator hopper base wiper blades 334 may be configured to continuously clean the perforated surfaces and prevent scale buildup. The evaporator hopper base wiper blades 334 are attached to a lower end of the hollow flight auger 324 and rotate along with the hollow flight auger 324 for sweeping the perforated plate 332 and the inside surface of the hopper base 348.

With continued reference to FIG. 3, a dual path rotary union 336 is positioned at the bottom of the hollow flight auger 324 to facilitate the transfer of heating fluid into and out of the rotating flight auger 324. An auger steam inlet 306 supplies steam to the hollow flight auger 324. A brine solids transfer tube 338 extends from the lower portion of the evaporator to a brine solids separator 342. A brine outlet 340 discharges concentrated brine from the ball mill evaporator system 300. An evaporator brine level indicator tube 318 monitors the brine level within the system. The evaporator brine level indicator tube 318 may include an elbow portion for maintaining connection with the ball mill evaporator.

The brine solids separator 342 is connected to a solids removal conveyor 344, which transports separated solids away from the ball mill evaporator system 300. The solids removal conveyor 344 is positioned at an incline and terminates at a solids outlet 346 for discharging the separated salt solids. In some aspects, the spherical grinding material 320 may be magnetic with approximately 30% chrome composition for separation using rotating magnetic means.

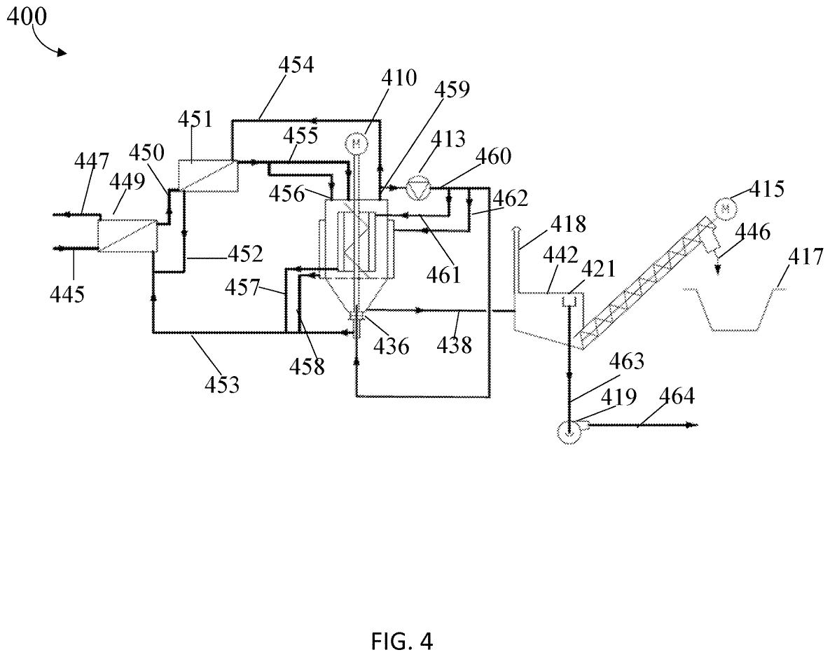

FIG. 4 illustrates a schematic diagram of a ball mill evaporator system 400 according to aspects of the present disclosure. The ball mill evaporator system 400 includes a ball mill evaporator integrated with heat recovery and brine processing components. The ball mill evaporator system may be configured with multiple parallel units, such as 5 parallel units with 4 in full-time operation and one on standby for rotation and rebuilding. Raw brine enters the ball mill evaporator system 400 through a raw brine inlet 445. The brine may include, but is not limited to, sodium chloride, magnesium chloride, calcium chloride, potassium chloride, barium sulfate, strontium sulfate, calcium sulfate, ferric hydroxide, manganese oxide, copper oxide, amorphous silica, crystalline silica, quartz, calcium carbonate, magnesium hydroxide and combinations thereof. The ball mill evaporator system processes brine with total dissolved solids (TDS) ranging from approximately 100,000 to approximately 250,000, with chloride salts comprising approximately 98% of the dissolved solids.

The raw brine passes through a heat exchanger 449, which preheats the incoming brine using recovered heat. A distillation condensate outlet 447 is connected to the heat exchanger 449 for removing condensate from the system. The preheated brine travels via a warmed brine line 450 to a latent heat exchanger 451, where additional heating occurs. The brine inlet temperature is at or near boiling point, with some boiling occurring in the latent heat exchanger 451.

With continued reference to FIG. 4, the heated brine is distributed to the ball mill evaporator through two feed paths: an auger area brine feed line 455 and an annular space brine feed line 456. The ball mill evaporator system 400 includes distribution components that rotate with the helical shaft connected to a nozzle assembly for delivering brine where needed. The dual feed path configuration allows co-feeding at different rates for efficient use of available heat.

An auger drive motor 410 powers the rotating mechanism within the evaporator. The evaporator includes an evaporator brine level indicator tube 418 for monitoring the brine level within the ball mill evaporator system. The evaporator brine level indicator tube 418 senses liquid level in the column despite varying density. In some embodiments, the evaporator brine level indicator tube 418 includes a detector positioned in fluid communication with the brine. The ball mill evaporator system may include a sensor or similar component to monitor density, moisture content, pressure, and/or temperature throughout the ball mill evaporator system. The density of the steam rate to brine ratio may be altered to generate a desired output. For example, and without limitation, the ball mill evaporator system may be configured to produce a saturated brine, an 80% salt slurry, a wet paste, and/or a dry crystallized output.

Steam generated during evaporation exits through an evaporator steam discharge line 459 and is directed to a steam vapor compressor 413. The steam vapor compressor 413 provides mechanical vapor recompression for energy recovery. The compressed steam travels through a steam vapor compressor outlet line 460 to an interior channel of the hollow flight auger of the ball mill evaporator system. The compressed steam is also distributed to heat the evaporator components (e.g., auger sleeve steam jacket and the evaporator wall steam jacket) via an auger sleeve steam jacket steam feed line 461 and an evaporator wall steam jacket steam feed line 462. Surplus steam exits through an evaporator surplus steam discharge 454, which connects to the latent heat exchanger 451.

Condensate from the steam jackets is collected through an auger sleeve steam jacket condensate discharge line 457 and an evaporator wall steam jacket condensate discharge line 458. These condensate streams combine in an auger and steam jacket condensate return line 453, which feeds into a hot condensate line 452 returning to the heat exchanger 449. The ball mill evaporator system may be connected to a condensation system, a mechanical vapor recompression system, and/or a drying system. The drying system may dry the salt slurry and/or cake to a solid salt using a dry component such as a hot air belt dryer.

With continued reference to FIG. 4, at the lower portion of the evaporator, a dual path rotary union 436 facilitates fluid transfer into and out of the rotating auger assembly. An evaporator hopper discharge line 438 directs material to a brine solids separator 442. The brine solids separator 442 includes a brine solids transfer connection for handling separated solids. The brine solids separator 442 includes a conical hopper designed body with an auger mounted at an inlet at the bottom operating at approximately 50% flood line. The ball mill evaporator system may include a series of deflectors and baffles to keep falling materials on track to the hopper and a weir that maintains minimum fluid height.

A solids removal conveyor, driven by a solids conveyor drive motor 415, transports separated solids through a solids outlet 446 to a solids disposal container 417. Concentrated brine is removed from the system via a brine concentrate discharge pump 419, which connects to a settled brine overflow drain line 463 and a brine discharge line 464 for final disposal or further processing. A weir 421 maintains a desired fluid height.

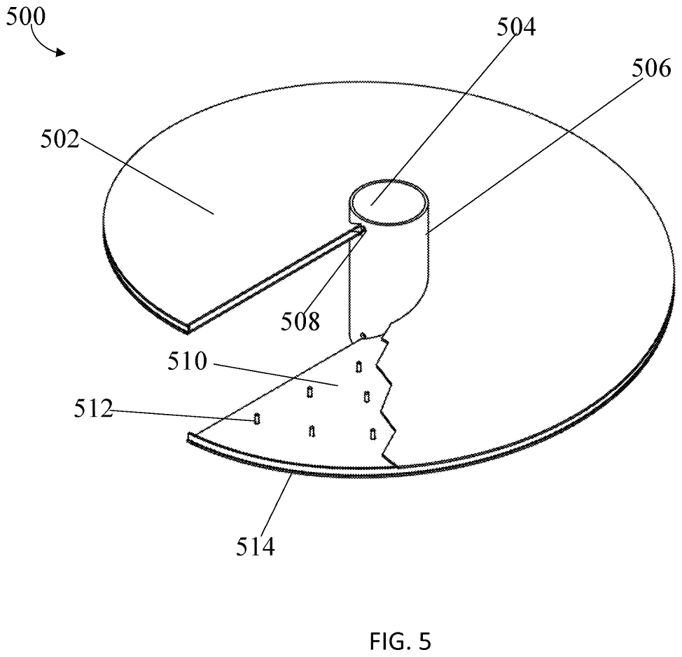

FIG. 5 illustrates a perspective view of a portion of a rotating mechanism of a ball mill evaporator system according to aspects of the present disclosure. The rotating mechanism 500 includes a screw with an upper face 502, a steam channel 504, a drive shaft 506, a steam duct 508, a lower face 510, a plurality of support pins 512, and a side face 514. The screw may be built in sections with steam-tight joints connecting adjacent sections. In some embodiments, the screw comprises 10 ft sections joined together to form a 40 ft height configuration. The sectional construction allows for sectional repairs. For example, when a bottom section experiences greater wear, the bottom section can be resurfaced or replaced without requiring disassembly of the entire screw.

With continued reference to FIG. 5, the rotating mechanism 500 may include a hollow flight configuration for receiving heated fluid via the steam channel 504. The hollow flight comprises a lower face 510 and an upper face 502 that together form a closed chamber when connected to a drive shaft 506. Support pins 512 are positioned on the inside of the rotating mechanism 500 and tie the lower face 510 to the upper face 502. The support pins 512 ensure alignment between the lower face 510 and the upper face 502.

According to aspects of the present disclosure, a method of solidifying dissolved minerals is disclosed. The method includes heating a plurality of spheres in a heating device to a temperature sufficient to superheat steam evolved from a brine. In some aspects, heating the plurality of spheres comprises heating the spheres to a temperature between about 100° C. and about 300° C. The plurality of spheres may include a corrosion-resistant material. In some embodiments, the corrosion-resistant material comprises stainless steel with approximately 30% chrome composition.

In some aspects, the method further comprises introducing the heated spheres into the brine at a lower end of a ball mill evaporator. The rotating mechanism, as described previously, comprises an Archimedes screw positioned at an incline relative to a horizontal surface. The Archimedes screw comprises insulation surrounding an exterior surface thereof to maintain thermal efficiency. In some embodiments, the ball mill evaporator comprises a vacuum tube surrounding the rotating mechanism to facilitate evaporation under reduced pressure conditions.

The method further comprises transporting the heated spheres from the lower end to an upper end of the ball mill evaporator using the rotating mechanism. While transporting, the spheres are continuously agitated to disengage salt scale adhered to surfaces of the spheres. The radial ribs within the hollow flight contribute to the agitation as the spheres travel along the screw surface.

The method further comprises directing steam from the heated spheres at the upper end to a condenser and collecting condensed steam from the condenser. The method further comprises transmitting the condensed steam to a storage container. The method further comprises separating salt from the spheres using a sorting component and returning the spheres to the heating device for reuse.

In some embodiments, a method for solidifying dissolved minerals comprises preheating raw brine using a sensible heat exchanger. The method further comprises further heating the preheated brine using a latent heat exchanger. The method further comprises distributing the heated brine to a ball mill evaporator through at least one feed path. The method further comprises transporting spherical grinding material from a lower position to a higher position within the ball mill evaporator using a rotating mechanism. The method further comprises continuously agitating the spherical grinding material while transporting to disengage salt scale adhered to surfaces of the spherical grinding material. The method further comprises generating steam during evaporation of the brine within the ball mill evaporator. The method further comprises directing the steam to a steam vapor compressor. The method further comprises compressing the steam using the steam vapor compressor. The method further comprises distributing the compressed steam to at least one steam jacket of the ball mill evaporator to provide heat to the ball mill evaporator. The method further comprises collecting condensate from the at least one steam jacket. The method further comprises returning the condensate to the sensible heat exchanger for heat recovery.

In at least one embodiment of the present disclosure, a ball mill evaporator system including a vertical ball mill is disclosed. The vertical ball mill can include at least two concentric chambers. The at least two concentric chambers includes a central chamber including a mounted auger that extends a full height of the ball mill. The auger is positioned for heated fluid to flow through an interior of the auger, resulting in a heat transfer surface for heating spheres traveling along the auger. Additionally, brine and salt slurry can accumulate on and contact the heat transfer surface as the spheres travel along the auger. The spheres can constantly remove accumulated brine and salt while traveling along the auger. The auger may include a double helix shape to maximize heat transfer surface area.

A circular volume of spheres is formed between the central auger sleeve and an exterior wall of the ball mill. The exterior wall is jacketed and is heated utilizing the same heating fluid as the auger. As the auger is rotated, the spheres moves from a bottom of the mill in the central chamber to a higher position, but less than an interior height of the mill. The spheres tumble over a top edge of the central chamber sleeve and impacts sphere positioned in the outer circular volume, resulting in disengagement of a salt scale on the surface of the spheres.

Brine can be introduced at an upper end of the mill and is designed to wet a surface of the spheres that are heated by the central auger before tumbling over the upper edge of the central sleeve. Steam exits the mill at the upper end. As spheres move from a lower end to an upper end of the mill, the spheres in the outer circular volume travel with the brine from top to bottom to continuously agitate the spheres against one another and against the mill wall to further disengage salt scale.

At a lower end of the ball mill evaporator, the spheres land on a perforated false floor that is continuously swept by radial blades. The radial blades can be attached to the lower end of the auger and rotated along with the auger. The sweeping by the radial blades disengages the salt accumulating in the perforations of the false floor at a lower end of the mill. The disengaged salt falls into a hopper positioned at a bottom of the mill housing. The ball mill evaporator system further includes means for conveying a semi-wet salt cake to storage.

In some embodiments of the present disclosure, the ball mill evaporator system may be connected to a condensation system, a mechanical vapor recompression system, a drying system. The ball mill evaporator system may receive raw water from an upstream feed. The ball mill evaporator system may, via a slurry conveyer, transmit a salt slurry and/or cake to a drying system. The drying system may dry the salt slurry and/or cake to a solid salt using a dry component (e.g., hot air belt dryer). The ball mill evaporator system may transmit steam to the mechanical vapor recompression system and/or the condensation system.

### Exemplary Ball Mill Evaporator System Embodiment

A. A ball mill evaporator system comprises a rotating mechanism including a lower end and an upper end, a brine, a condenser, and a sorting component. The rotating mechanism receives heated media at the lower end. The heated media traverses the rotating mechanism from the lower end to the upper end. While traversing from the lower end to the upper end, the heated media is continuously agitated. At the upper end, steam of the heated media is directed to the condenser. The heated media is cooled. The cooled media is directed into the sorting component. The sorting component separates scale from the cooled media. The cooled media is directed to a heating device.

B. The ball mill evaporator system according to Paragraph A, wherein the heating device heats the media prior to being exposed to the brine.

C. The ball mill evaporator system according to any of Paragraph A or B, wherein the rotating mechanism includes an Archimedes screw.

D. The ball mill evaporator system according to any of Paragraphs A to C, wherein the rotating mechanism is positioned at an incline.

E. The ball mill evaporator system according to any of Paragraphs A to D, further comprising means for monitoring a density of the brine.

### Exemplary Ball Mill Evaporator System Embodiment

A. A ball mill evaporator system comprising a rotating mechanism including a central portion and an outer portion, a brine, and a self-cleaning component. The rotating mechanism is in fluid communication with at least one fluid stream, wherein the at least one fluid stream flows through an interior channel of the central portion, wherein the at least one fluid stream is heated. The rotating mechanism moves media from a lower position to a higher position, wherein as the media moves from the lower position to the higher position, the media is heated via heat transfer from the at least one heated fluid stream, wherein scale adhered to a surface of the media descales as the media traverses the rotating mechanism, wherein, once the media reaches the higher position, the media is operable to move from the central portion to the outer portion. The media falls onto a bottom of the outer portion, wherein the self-cleaning component scrapes the media to remove the scale adhered to the surface of the media, wherein the scale is collected in an outlet.

B. The ball mill evaporator system according to Paragraph A, wherein the rotating mechanism includes an auger.

C. The ball mill evaporator system according to Paragraph A or B, wherein the media includes a plurality of spherical balls, wherein the plurality of spherical balls comprise a corrosion-resistant material.

D. The ball mill evaporator system according to any of Paragraphs A to C, wherein, after the self-cleaning component scrapes the media to remove scale, the media reenters the rotating mechanism.

E. The ball mill evaporator system according to any of Paragraphs A to D, wherein, when the heated media is at the higher position, steam from the heated media is captured and directed to a condenser.

### Exemplary Method of Solidifying a Dissolved Mineral

A. A method of solidifying a dissolved mineral comprising: (1) heating media via a heating device; (2) introducing the heated media into a solution, wherein the solution comprises a dissolved mineral, wherein the solution is positioned at a first end of a rotating mechanism of a ball mill evaporator; (3) transporting the heated media from the first end of the rotating mechanism to a second end of the rotating mechanism; (4) continuously agitating the heated media to disengage scale adhered to a surface of the heated media; (5) directing, at the second end of the rotating mechanism, steam from the heated media to a condenser; (6) collecting condensate from the condenser; (7) separating solidified scale from the media; and (8) returning the media to the heating device.

B. The method according to Paragraph A, wherein media includes a plurality of spherical balls, wherein the plurality of spherical balls comprise a corrosive-resistant material.

C. The method according to Paragraph A or B, wherein the solution comprises a brine.

D. The method according to any of Paragraphs A to C, wherein the solution comprises at least one of sodium chloride, barium sulfate, strontium sulfate, calcium sulfate, ferric hydroxide, manganese oxide, copper oxide, amorphous silica, crystalline silica, quartz, calcium carbonate, and magnesium hydroxide.

E. The method according to any of Paragraph A to D, wherein the rotating mechanism comprises a helical auger.

The corresponding structures, materials, acts, and equivalents of all means or step plus function elements in the claims below are intended to include any structure, material, or act for performing the function in combination with other claimed elements as specifically claimed.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A ball mill evaporator system comprising:
a rotating mechanism including a lower end and an upper end;
a brine;
a condenser; and
a sorting component;
wherein the rotating mechanism receives heated media at the lower end, wherein the heated media traverses the rotating mechanism from the lower end to the upper end, wherein, while traversing from the lower end to the upper end, the heated media is continuously agitated, wherein at the upper end, steam of the heated media is directed to the condenser, wherein the heated media is cooled, wherein the cooled media is directed into the sorting component, wherein the sorting component separates scale from the cooled media, and wherein the cooled media is directed to a heating device.

2. The ball mill evaporator system of claim 1, wherein the heating device heats the media prior to being exposed to the brine.

3. The ball mill evaporator system of claim 1, wherein the rotating mechanism includes an Archimedes screw.

4. The ball mill evaporator system of claim 1, wherein the rotating mechanism is positioned at an incline.

5. The ball mill evaporator system of claim 1 further comprising means for monitoring a density of the brine.

6. A ball mill evaporator system comprising:
a rotating mechanism including a central portion and an outer portion;
a brine; and
a self-cleaning component;
wherein the rotating mechanism is in fluid communication with at least one fluid stream, wherein the at least one fluid stream flows through an interior channel of the central portion, wherein the at least one fluid stream is heated,
wherein the rotating mechanism moves media from a lower position to a higher position, wherein as the media moves from the lower position to the higher position, the media is heated via heat transfer from the at least one heated fluid stream, wherein scale adhered to a surface of the media descales as the media traverses the rotating mechanism, wherein, once the media reaches the higher position, the media is operable to move from the central portion to the outer portion; and
wherein the media falls onto a bottom of the outer portion, wherein the self-cleaning component scrapes the media to remove the scale adhered to the surface of the media, wherein the scale is collected in an outlet.

7. The ball mill evaporator system of claim 6, wherein the rotating mechanism includes an auger.

8. The ball mill evaporator system of claim 6, wherein the media includes a plurality of spherical balls, wherein the plurality of spherical balls comprise a corrosion-resistant material.

9. The ball mill evaporator system of claim 6, wherein, after the self-cleaning component scrapes the media to remove scale, the media reenters the rotating mechanism.

10. The ball mill evaporator system of claim 6, wherein, when the heated media is at the higher position, steam from the heated media is captured and directed to a condenser.

11. A method of solidifying a dissolved mineral comprising:
heating media via a heating device;
introducing the heated media into a solution, wherein the solution comprises a dissolved mineral, wherein the solution is positioned at a first end of a rotating mechanism of a ball mill evaporator;
transporting the heated media from the first end of the rotating mechanism to a second end of the rotating mechanism;
continuously agitating the heated media to disengage scale adhered to a surface of the heated media;
directing, at the second end of the rotating mechanism, steam from the heated media to a condenser;
collecting condensate from the condenser;
separating solidified scale from the media; and
returning the media to the heating device.

12. The method of claim 11, wherein media includes a plurality of spherical balls, wherein the plurality of spherical balls comprise a corrosion-resistant material.

13. The method of claim 11, wherein the solution comprises a brine.

14. The method of claim 13, wherein the solution comprises at least one of sodium chloride, barium sulfate, strontium sulfate, calcium sulfate, ferric hydroxide, manganese oxide, copper oxide, amorphous silica, crystalline silica, quartz, calcium carbonate, and magnesium hydroxide.

15. The method of claim 11, wherein the rotating mechanism comprises a helical auger.
